(19) United States
(12) Patent Application Publication
(10) Pub. No.: US 2006/0262804 A1
(43) Pub. Date: Nov. 23, 2006

(54) Method of providing multiprotocol cache service among global storage farms

(76) Inventors: Moon Ju Kim, Wappinger Falls, NY (US); Dikran Meliksetian, Danbury, CT (US); Robert Glenn Oesterlin, Rochester, MN (US); Judith S. Warren, Southbury, CT (US)

Correspondence Address: F. CHAU & ASSOCIATES, LLC, 130 WOODBURY ROAD, WOODBURY, NY, 11797, US

(21) Appl. No.: 11/131,946

(22) Filed: May 18, 2005

(51) Int. Cl. H04L 12/56

(52) U.S. Cl. 370/412

(57) ABSTRACT

Exemplary multiprotocol cache services and exemplary methods for accessing such multiprotocol cache services are provided. An exemplary multiprotocol cache includes a plurality of data storage cells; and a plurality of cache servers operatively connected to the data storage cells, wherein each of the plurality of cache servers comprises a cache for caching data for the plurality of data storage cells.

### BACKGROUND OF THE INVENTION

1. Field of the Invention

The present invention relates generally to the field of data storage, and, more particularly, to a method of providing multiprotocol cache service among global storage farms.

2. Description of the Related Art

The growth of information technology has, among other things, spurred the advancement of data storage technologies. Enterprise Storage Systems (“ESS”) generally provide multiple data storage cells (i.e., farms) for storing and sharing large quantities (e.g., terabytes) of data among individuals in an enterprise. The storage cells are typically deployed in various locations throughout a country or the world. ESS may provide a data management mechanism, a data security mechanism, and a user authentication mechanism.

It should be noted that although the storage cells are deployed around the world, users view the ESS as a logical, centralized file system. That is, the complexity of the ESS is effectively hidden from the users. For example, when a user requests data from the ESS, the ESS may traverse the multiple storage cells to find the data, so the user is not required to know which storage cell contains the requested data.

An exemplary ESS provided by IBM® is referred to as Global Storage Architecture (“GSA”). GSA, which is deployed worldwide, provides a low-cost file service for internal users in an enterprise. An exemplary GSA 100 is shown in FIG. 1. Referring now to FIG. 1, a GSA cell 105 is operatively connected to a plurality of client computers 110 through a network connection 115. The GSA cell 105 may support any of a variety of protocols, such as such as hypertext transfer protocol (“HTTP”), file transfer protocol (“FTP”), network file system (“NFS”) and common internet file system (“CIFS”). The network connection 115 may be local area network (“LAN”) or a wide area network (“WAN”). The plurality of user computers 110 may be interconnected using, for example, the same or another LAN (e.g., local network 160).

The GSA cell 105 includes a GPFS (General Parallel File System) storage 120, service delivery agents 125, security module 130, a load balance module 135, a performance monitor 140 and a tape library 145. The GPFS storage 120 is operatively connected to the service delivery agents 125 via a storage area network (“SAN”) 150. The service delivery agents 125 may include a plurality of servers. The service delivery agents 125 receive and process data between the GPFS storage 125 and the user computers 110 via an ethernet connection 155. Operatively connected to the SAN 145 is the tape library 145. The tape library 145 provides tape backup for the GPFS Storage 120. Operatively connected to the ethernet connection 155 are the security module 130, the load balance module 135 and the performance monitor 140. The security module 130 includes a plurality of lightweight directory access protocol (“LDAP”) servers for providing user authentication. The security module 130 may be operatively connected to a master security database (not shown) containing user authentication data. The load balance module 135 includes a plurality of network dispatchers for balancing the load among the service delivery agents 125. The load balance module 135 may further provide failover if any of the servers in the GPFS storage 120 fail to properly operate. The performance monitor 140 monitors the performance of the entire GSA cell 105.

Because the storage cells in an ESS may be deployed worldwide, a problem generally arises when users require time-sensitive access to data in the storage cells. That is, the physical distance from a particular user to the storage cell storing the requested data may inhibit sufficiently fast access to the data. For example, GSA storage cells are currently deployed at 19 sites worldwide. Because relatively few sites are available, it likely follows that a particular user may be physically distant from the storage cell containing the user's requested information. A significant physical distance between the storage cell containing the user's requested information and the user generally increases network latency. This increase in network latency is especially problematic in high performance applications.

One solution may be to increase the number of storage cells. However, deploying additional full-sized storage cells (e.g., >one terabyte) may be prohibitively expensive. Another solution may be to deploy smaller, less-expensive storage cells (e.g., <500 GB), which is about 1/10^{th} of the cost of a full-sized storage cell. Although ESS provides some limited scalability, deploying smaller storage cells (e.g., under 500 GB) may still be prohibitively expensive. The smaller ESS cells may require a significant amount of additional infrastructure, local support and maintenance.

### SUMMARY OF THE INVENTION

In one aspect of the present invention, a multiprotocol cache service is provided. The multiprotocol cache service includes a plurality of data storage cells; and a plurality of cache servers operatively connected to the data storage cells, wherein each of the plurality of cache servers comprises a cache for caching data for the plurality of data storage cells.

In another aspect of the present invention, a method for accessing a multiprotocol cache service is provided. The method includes receiving a request for data from a client; if the request is a read request and the data is cached in one of a plurality of caches operatively connected to a plurality of data storage cells, sending the data to the client from the one of the plurality of caches; if the request is a read request, and the data is missing in the plurality of caches, fetching the data from the plurality of data storage cells, storing the data in at least one of the plurality of caches, and sending the data to the client; and if the request is a write request, updating at least one of the plurality of caches with the data, and sending the data to the plurality of data storage cells.

In yet another aspect of the present invention, a multiprotocol cache service is provided. The multiprotocol cache service includes a plurality of Global Storage Architecture (GSA) cells; and a plurality of broken cache servers operatively connected to the GSA cells, wherein each of the plurality of broken cache servers comprises a cache for caching data for the plurality of GSA cells.

### BRIEF DESCRIPTION OF THE DRAWINGS

The invention may be understood by reference to the following description taken in conjunction with the accompanying drawings, in which like reference numerals identify like elements, and in which:

FIG. 1 depicts a typical global storage architecture;

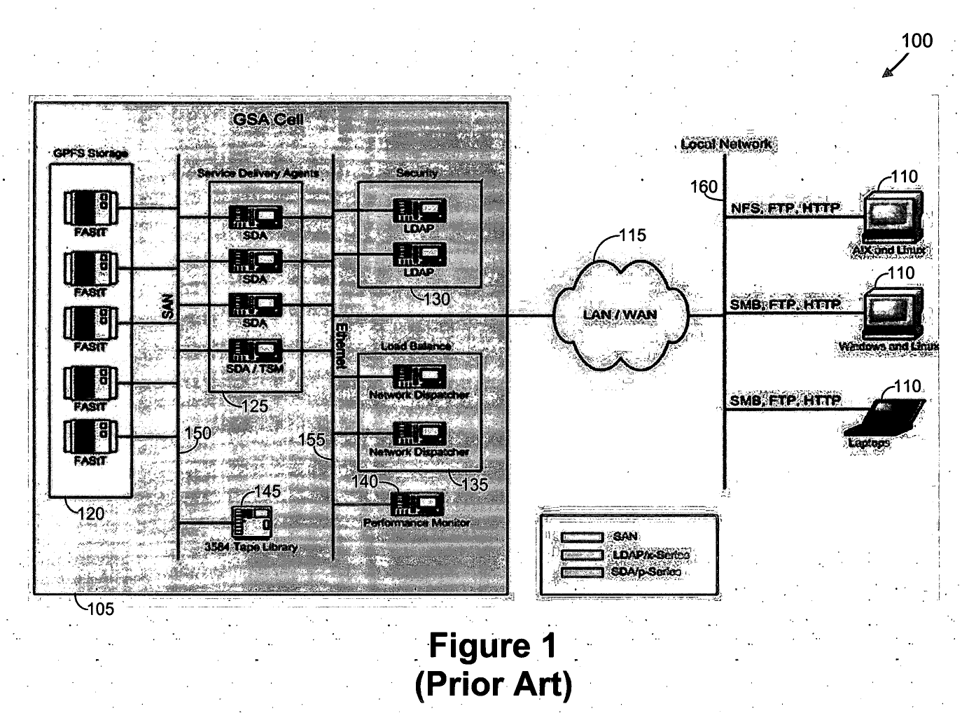

FIG. 2 depicts a block diagram illustrating a multiprotocol cache service, in accordance with one exemplary embodiment of the present invention;

FIG. 3 depicts a flow diagram illustrating a method for accessing a multiprotocol cache service, in accordance with one exemplary embodiment of the present invention; and

FIG. 4 depicts a block diagram illustrating a broken cache, in accordance with one exemplary embodiment of the present invention.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims. It is to be understood that the systems and methods described herein may be implemented in various forms of hardware, software, firmware, special purpose processors, or a combination thereof.

We present an extension of the traditional data storage cells used in enterprise storage systems (“ESS”), such as the global storage architecture (“GSA”) offered by IBM®. The extension includes dedicated caching servers operatively connected the data storage cells. The dedicated caching servers may be deployed at strategic locations close to the users. Instead of communicating with the data storage cells directly, the users communicate with the dedicated caching servers. Because the dedicated caching servers are deployed at locations closer to the user than the data storage cells, the users do not suffer unnecessary network latency from excess network traffic. The dedicated caching servers also increase the data storage cell usage coverage, and decrease the load on the data storage cells. Further, deploying the dedicated caching servers is significantly less expensive than deploying a scaled-down data storage cell.

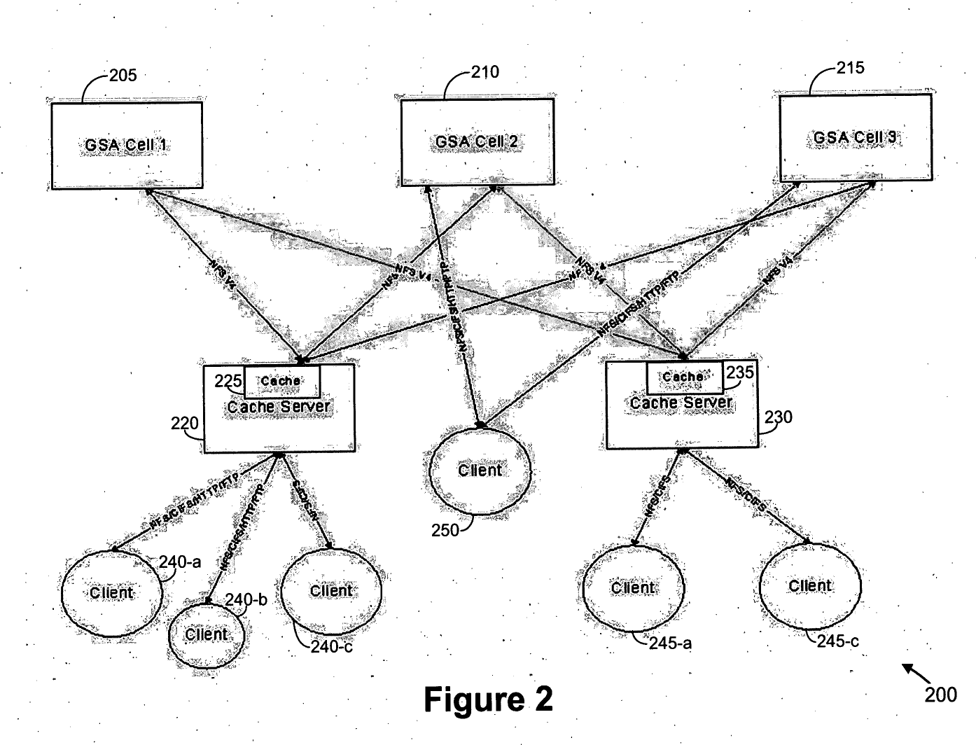

Referring now to FIG. 2, a exemplary ESS 200 with dedicated caching servers is shown, in accordance with one embodiment of the present invention. The ESS 200 includes a first ESS cell 205, a second ESS cell 210 and a third ESS cell 215. In FIG. 2, the plurality of ESS cells 205, 210, 215 are GSA cells offered by IBM®. A first cache server 220 with a first cache 225 and a second cache server 230 with a second cache 235 are each operatively connected to the plurality of ESS cells 205, 210, 215 via a network file system version 4 (“NFS V4”) protocol. The NFS V4 protocols ensure consistency between the plurality of cache servers 220, 230 and the plurality of ESS cells 205, 210, 215. The first set of clients 240-a, 240-b, 240-c (collectively 240) is operatively connected to the first cache server 220 via any of a variety of protocols, such as hypertext transfer protocol (“HTTP”), file transfer protocol (“FTP”), network file system (“NFS”) and common internet file system (“CIFS”). A second set of clients 245-a, 245-b (collectively 245) is similarly operatively connected to the second cache server 230 via any of a variety of protocols, such as HTTP, FTP, NFS and CIFS. A third set of clients 250 is operatively connected to the second ESS cell 210 and the third ESS cell 215 via any of a variety of protocols, such as HTTP, FTP, NFS and CIFS. The third set of clients 250 may not be at a location that is not served by a cache server (e.g., plurality of cache servers 220, 230). Whether a client communicates directly with a ESS cell or through a cache server may be determined by a user when the ESS cell (e.g., GSA) client code is established. The determination whether to communicate directly with a ESS cell or through a cache server may be changed later.

The plurality of caching servers 220, 230 may be deployed at locations that could not otherwise support a GSA cell or where increased performance over remotely accessing the GSA cell is required. The plurality of caching servers 220, 230 communicate directly with the plurality of ESS cells 205, 210, 215. The first set of clients 240 and the second set of clients 245 receive file services from the plurality of caching servers 220, 230 instead of directly from the plurality of ESS cells 205, 210, 215.

Consider an exemplary read request from a client 240-a. When the client 240-a requests data, a read request is sent from the client 240-a to the first cache server 220. If the requested data is present in the cache 225 of the first cache server 220, the first cache server 220 fulfills the read requests and sends the requested data to the client 240-a. If the requested data is not in the cache 225 of the first cache server 220, the first cache server 220 fetches the requested data from one of the plurality of GSA cells 205, 210, 215, places the data in the cache 225, and forwards the requested data to the client 240-a.

Consider an exemplary write request from a client 245-a. When the client 245-a sends a file to the second cache server 225, the second cache server 225 forwards the file to the master ESS cell.

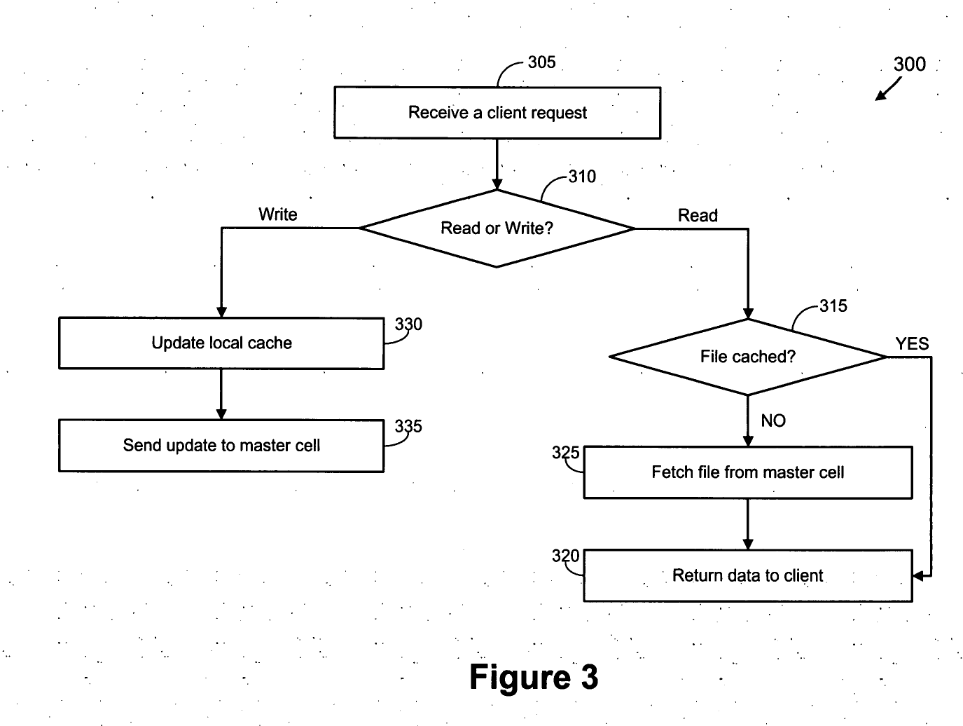

Referring now to FIG. 3, an exemplary flow diagram 300 is shown, illustrating a method of performing reads and writes using an exemplary ESS with dedicated caching servers, as described in greater detail above, in accordance with one embodiment of the present invention. A cache server receives (at 305) a request from a client. The cache server determines (at 310) whether the request is a read or a write. If the request is determined (at 310) to be a read request, then it is determined (at 315) whether the requested file of the read request is cached in the cache server. If the requested file is determined (at 315) to be cached in the cached server, then the requested file is returned (at 320) from the cache server to the client. If the requested file is determined (at 315) to not be cached in the cached server, then the requested file is fetched (at 325) from a master ESS cell and stored in the cache server. The requested file is then returned (at 320) to the client. If the request is determined (at 315) to be a write request, then the cache server is updated (at 330) with the new file of the write request. The new file is sent (at 335) to the master ESS cell for updating the ESS cell.

Generally, a cache server is initially configured as a single unit unless groups have been identified and their requirements are documents. In the present invention, the cache to be partitioned so that various groups can use a larger portion of the cache.

Referring again to FIG. 2, it should be appreciated that the plurality of cache servers 220, 230 may be broken into multiple independently-managed sections. The sections may be managed by a policy, which ensures that the data needed by the clients 240, 245 is kept in the cache.

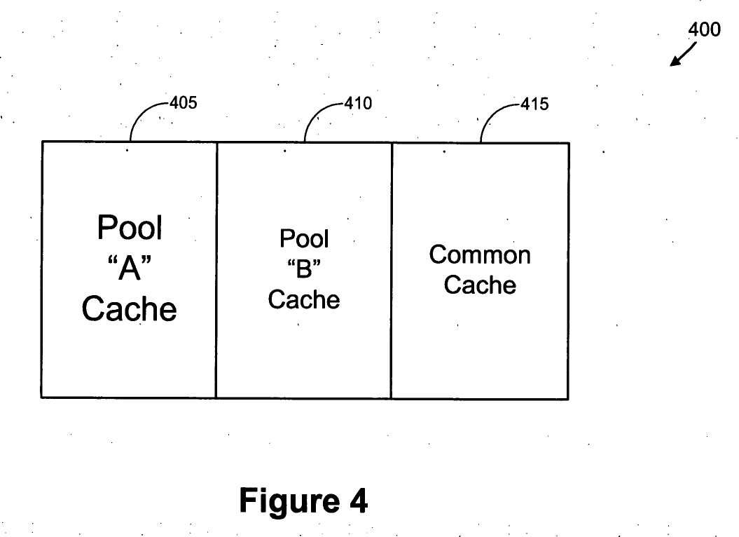

Consider, for example, a set of developers working on a common set of software components. Referring now to FIG. 4, an exemplary broken cache 400, which is part of a cache server (not shown), is shown, in accordance with one embodiment of the present invention. The broken cache 400 includes a pool “A” cache 405, a pool “B” cache 410 and a common cache 415. The sizes of the pool “A” cache 405, the pool “B” cache 410 and the common cache 415 are determined by the policy, and, accordingly, can be changed by updating the policy. A first group of users are associated with the pool “A” cache 405. A second group of users are associated with the pool “B” cache 410. The remaining users not in the first group of users or the second group of users will have files cached out of the common cache 415.

It should be appreciated that the capacity of the server depends on any of a variety of factors, such as population of the users, usage patterns, and management policy.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A multiprotocol cache service, comprising:
a plurality of data storage cells; and
a plurality of cache servers operatively connected to the data storage cells, wherein each of the plurality of cache servers comprises a cache for caching data for the plurality of data storage cells.

2. The multiprotocol cache service of claim 1, further comprising:
a plurality of clients capable of accessing the data in the plurality of data storage cells through the plurality of cache servers.

3. The multiprotocol cache service of claim 2, wherein the plurality of clients comprises a first set of clients for accessing the data in the plurality of data storage cells through the plurality of cache servers and a second set of clients for accessing the data directly with the plurality of cache servers.

4. The multiprotocol cache service of claim 3, wherein each of the first set of clients is associated with one of the plurality of data storage cells to which the each of the first set of clients is geographically closest.

5. The multiprotocol cache service of claim 3, wherein each of the second set of clients is geographically closer to the plurality of data storage cells than to the plurality of cache servers.

6. The multiprotocol cache service of claim 1, wherein the plurality of data storage cells, comprise:
a plurality of Enterprise Storage System (ESS) cells.

7. The multiprotocol cache service of claim 6, wherein the plurality of Enterprise Storage System (ESS) cells, comprise:
a plurality of Global Storage Architecture (GSA) cells.

8. The multiprotocol cache service of claim 1, wherein the plurality of cache servers communicate with the plurality of data storage cells using NFS v4 protocols.

9. The multiprotocol cache service of claim 1, wherein each of the plurality of cache servers are divided into a plurality of sections, and wherein each of the plurality of sections is independently managed by a policy.

10. The multiprotocol cache service of claim 9, wherein the plurality of sections, comprises:
at least one client section capable of being accessed by at least one client; and
a common section capable of being accessed by every client.

11. The multiprotocol cache service of claim 9, wherein the policy for the each of the plurality of sections determines the size of the each of the plurality of sections.

12. The multiprotocol cache service of claim 1, wherein each of the plurality of data storage cells, comprises:
a General Parallel File System (GPFS) storage unit;
a plurality of service delivery agents;
a tape library;
a first network operatively connecting the GPFS storage unit, the plurality of service delivery agents, and the tape library;
a security unit;
a load balance;
a performance monitor; and
a second network operatively connecting the security unit, the load balance, the performance monitor, and the plurality of service delivery agents.

13. The multiprotocol cache service of claim 1, wherein each of the plurality of data storage cells and each of the plurality of cache servers are capable of supporting a plurality of protocols for communicating with clients.

14. The multiprotocol cache service of claim 13, wherein the plurality of protocols comprises HTTP, FTP, NFS and CIFS.

15. A method for accessing a multiprotocol cache service, comprising:
receiving a request for data from a client;
if the request is a read request and the data is cached in one of a plurality of caches operatively connected to a plurality of data storage cells,
sending the data to the client from the one of the plurality of caches;
if the request is a read request, and the data is missing in the plurality of caches,
fetching the data from the plurality of data storage cells,
storing the data in at least one of the plurality of caches, and
sending the data to the client; and
if the request is a write request,
updating at least one of the plurality of caches with the data, and
sending the data to the plurality of data storage cells.

16. The method of claim 15, further comprising:
establishing whether each of a plurality of clients directly communicates with one of the plurality of data storage cells or through one of the plurality caches operatively connected to the plurality of data storage cells.

17. The method of claim 15, wherein the plurality of data storage cells, comprise:
a plurality of Enterprise Storage System (ESS) cells.

18. The method of claim 17, wherein the plurality of Enterprise Storage System (ESS) cells, comprise:
a plurality of Global Storage Architecture (GSA) cells.

19. A multiprotocol cache service, comprising:
a plurality of Global Storage Architecture (GSA) cells; and
a plurality of broken cache servers operatively connected to the GSA cells, wherein each of the plurality of broken cache servers comprises a cache for caching data for the plurality of GSA cells.

20. The multiprotocol cache service of claim 19, further comprising:
a first client operatively connected to one of the plurality of broken cache servers for reading data from and writing data to the plurality of GSA cells.

21. The multiprotocol cache service of claim 20, further comprising:
a second client operatively connected to the plurality of GSA cells for directly reading data from and directly writing data to the plurality of GSA cells.
